(19) United States
(12) Patent Application Publication
(10) Pub. No.: US 2018/0013978 A1
(43) Pub. Date: Jan. 11, 2018

(54) VIDEO SIGNAL CONVERSION METHOD, VIDEO SIGNAL CONVERSION DEVICE AND DISPLAY SYSTEM

(71) Applicant: BOE TECHNOLOGY GROUP CO., LTD., Beijing (CN)

(72) Inventors: Ran DUAN, Beijing (CN); Lihua GENG, Beijing (CN)

(73) Assignee: Boe Technology Group Co., Ltd., Beijing (CN)

(21) Appl. No.: 15/541,923

(22) PCT Filed: Feb. 18, 2016
(86) PCT No.: PCT/CN2016/074030

§ 371 Date: Jul. 6, 2017

(30) Foreign Application Priority Data
Sep. 24, 2015 (CN) 201510617475.X

(51) Int. Cl. H04N 7/01; H04N 9/67

(52) U.S. Cl. CPC H04N 7/0125; H04N 9/67

(57) ABSTRACT

A video signal conversion method, a corresponding video signal conversion device and a display system including the video signal conversion device, by which low-resolution video signals can be converted and combined into a high-resolution video signal, such that a high-resolution image combined by low-resolution images can be displayed on an ultra-high definition display screen. The video signal conversion method includes: receiving in parallel a plurality of sub-frames divided from a low-resolution image of a video signal; performing image processing on each of the received sub-frames; and synthesizing the plurality of sub-frames after being subjected to the image processing into a high-resolution image frame and displaying the high-resolution image on a display device.

### TECHNICAL FIELD

The present disclosure relates to the field of video displaying, and more particularly to a video signal conversion method, a video signal conversion apparatus corresponding thereto and a display system comprising the video signal conversion apparatus.

### BACKGROUND

With the rapid development of display technology, resolution of the display panel becomes higher and higher, which enables the ultra-high-definition display screen to be gradually applied into various fields. In order to match with such ultra-high-definition display screen, a playback device capable of playing an ultra-high-definition video signal is required. However, at present, such playback device capable of playing an ultra-high-definition video signal has a high cost, and thus it is hard for the ultra-high-definition display system to be popular.

On the other hand, in some application scenarios, for example, scenarios where electronic identification needs to be displayed with a high resolution (e.g., 10248*4320, 10K4K), like a billboard, a public information indicator board, a conference bulletin board etc., it might be unnecessary for a source signal to have a high frequency, for example, 15 Hz probably suffices to meet requirements; however, since the ultra-high-definition display screen typically uses a relatively high (e.g., 60 Hz) scan frequency at present, the source signal needs to be converted so as to match with the ultra-high-definition display screen and to be displayed thereon.

### SUMMARY

In view of the above, the present disclosure provides a video signal conversion method, a video signal conversion apparatus corresponding thereto and a display system comprising the video signal conversion apparatus, with which a video signal with a low resolution (e.g., 5124*2160, 5K2K) can be converted and stitched into a video signal with a high resolution (e.g., 10K4K), so that a video player that plays a video signal with a low resolution (e.g., 5K2K@60 Hz) can be matched with an ultra-high-definition (e.g., 10K4K@60 Hz) display screen to thereby form a display system, in which a high resolution image stitched from low resolution images is displayed on the ultra-high-definition display screen.

According to an aspect of the present disclosure, there is provided a video signal conversion method, comprising: receiving in parallel a plurality of sub-frames segmented from a low resolution image of a video signal; performing image processing on each received sub-frame; and synthesizing a plurality of sub-frames that have been subjected to image processing into one frame of high resolution image to be displayed on a display device.

Optionally, image processing is performed in parallel on a plurality of sub-frames segmented from one frame of low resolution image in a plurality of processing channels.

Optionally, the image processing comprises at least one of color space conversion, color enhancement processing, frame rate conversion and pixel format conversion.

Optionally, the number of the plurality of sub-frames into which a low resolution image is segmented is determined based on at least one of a resolution of the low resolution image and a transmission rate of a data port for receiving the low resolution image.

Optionally, the color space conversion comprises converting the sub-frames from RGB color space to YUV color space.

Optionally, a multiple of the frame rate conversion is determined based on a ratio of the resolution of the high resolution image to that of the low resolution image.

Optionally, a plurality of sub-frames that have been subjected to frame rate conversion are converted into an LVDS signal by pixel format conversion, and the LVDS signal is converted into a V-BY-ONE signal by signal format conversion to be outputted to a display device.

According to another aspect of the present disclosure, there is provided a video signal conversion apparatus, comprising: a video signal receive port for receiving in parallel a plurality of sub-frames segmented from a low resolution image; an image processor for performing image processing on each received sub-frame; and a video signal output port for outputting a plurality of sub-frames that have been subjected to image processing to a display device so as to be synthesized into one frame of high resolution image to be displayed.

Optionally, the image processor performs image processing in parallel on a plurality of sub-frames segmented from one frame of low resolution image over a plurality of processing channels.

Optionally, the image processor comprises: a color space conversion part for performing color space conversion on received sub-frames; a color enhancement part for performing color enhancement processing on sub-frames that have been subjected to color space conversion; a frame rate conversion part for performing frame rate conversion on sub-frames that have been subjected to color enhancement processing; and a pixel format conversion part for performing pixel format conversion on sub-frames that have been subjected to frame rate conversion so as to output the same to a video signal output port.

Optionally, the video signal conversion apparatus according to the present disclosure further comprises a signal format conversion part, wherein a plurality of sub-frames that have been subjected to frame rate conversion are converted into an LVDS signal by the pixel format conversion part, and the LVDS signal is converted into a V-BY-ONE signal to be outputted to a display device by the signal format conversion part.

Optionally, the video signal receive port is a DVI port, and the video signal output port is a V-BY-ONE port.

Optionally, the low resolution image has a resolution of 5124*2160, and the high resolution image has a resolution of 10248*4320.

Optionally, the image processor is implemented by one or more FPGA.

According to yet another aspect of the present disclosure, there is provided a display system, comprising a playback device, a high-definition display and the video signal conversion apparatus as described in the above.

In the video signal conversion method, the video signal conversion apparatus and the display system according to the present disclosure, a video image with a relatively low resolution can be stitched into a video image with a high resolution on an ultra-high-definition display screen for displaying, so that a playing device for playing a video image with a low resolution can be compatible with an ultra-high-definition display screen for displaying a video image with a high resolution, thus displaying the high resolution image, enhancing compatibility, reducing cost of the display system, and facilitating the popularity of the high-definition display system.

### BRIEF DESCRIPTION OF THE DRAWINGS

In order to more clearly illustrate the technical solutions in the embodiments of the present disclosure, hereinafter, the drawings necessary for illustration of the embodiments will be introduced briefly. Apparently, the drawings described below only involve some embodiments of the present disclosure, rather than intended to limit the present disclosure.

FIG. 1 is a flowchart of a video signal conversion method according to an embodiment of the present disclosure;

FIG. 2A is a schematic diagram of segmenting one frame of low resolution (e.g., 5K2K) image into a plurality of sub-frames according to an embodiment of the present disclosure;

FIG. 2B is a schematic diagram of transmitting one sub-frame using a plurality of DVI ports according to an embodiment of the present disclosure;

FIGS. 3A-3B are schematic diagrams of transmitting a plurality of sub-frames using a plurality of DVI ports according to an embodiment of the present disclosure each;

FIG. 3C is a schematic diagram of stitching a plurality of sub-frames into one frame of high resolution image according to an embodiment of the present disclosure;

FIG. 4A is a flowchart of a method of performing image processing on a video signal according to an embodiment of the present disclosure;

FIG. 4B illustrates corresponding schematic processing flows;

FIG. 5 is a schematic diagram of stitching a plurality of received sub-frames that have been subjected to image processing into one frame of high resolution (e.g., 10K4K) image using a timing controller (T-CON) on a display screen according to an embodiment of the present disclosure;

FIG. 6 is a schematic block diagram of a video signal conversion apparatus according to an embodiment of the present disclosure; and

FIGS. 7A-7B are schematic block diagrams of a display system according to an embodiment of the present disclosure each.

### DETAILED DESCRIPTION OF THE EMBODIMENTS

Hereinafter, the technical solutions in the embodiments of the present disclosure will be described clearly and comprehensively in combination with the drawings. Obviously, these described embodiments are merely parts of the embodiments of the present disclosure, rather than all of the embodiments thereof. Other embodiments obtained by a person of ordinary skill in the art based on the embodiments of the present disclosure without paying creative efforts all fall into the protection scope of the present disclosure.

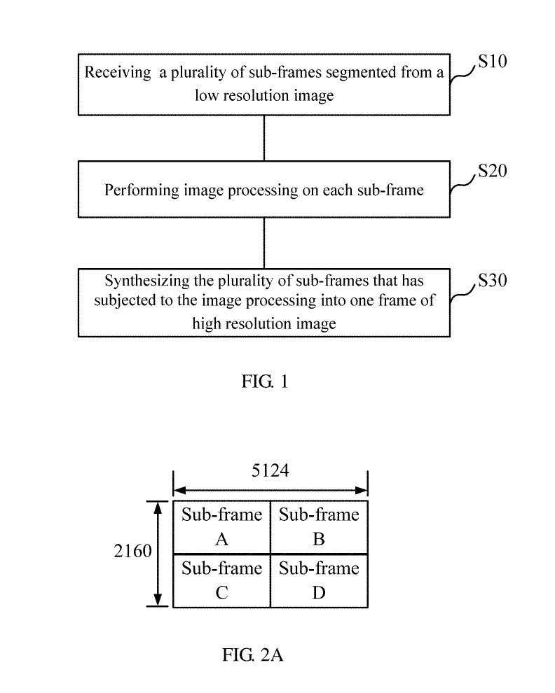

As described above, for a conventional playback device for playing a low resolution video signal to be compatible with a high resolution display screen for displaying a high resolution video signal, according to an aspect of the present disclosure, there is provided a video signal conversion method, with which a plurality of frames of low resolution image of a video signal can be synthesized into one frame of high resolution image, so that the playback device for playing the low resolution video image and the high resolution display screen can form a display system to display the high resolution image. As an example, the video signal conversion method according to the present disclosure can process a low resolution image of 5K2K outputted from the playback device for playing a low resolution video image, and then stitch the processed low resolution images into a high resolution image of 10K4K to be displayed. It should be noted that the low resolution 5K2K and the high resolution 10K4K mentioned above are merely examples introduced to explain the principles of the embodiments of the present invention, in fact, the video signal conversion method of the present disclosure is not limited to the aforesaid resolutions, but can be applied to other various resolutions while maintaining the principle of the present disclosure. In the case of a high-definition display with a resolution of 10K4K, one frame of high resolution image of 10K4K can be synthesized from a plurality of frames of low resolution video image according to the principles of the present disclosure. As illustrated in FIG. 1, the video signal conversion method according to an embodiment of the present disclosure comprises: S10, receiving a plurality of sub-frames segmented from a low resolution image of a video signal; S20, performing image processing on each received sub-frame; and S30, synthesizing a plurality of sub-frames that have been subjected to image processing into one frame of high resolution image.

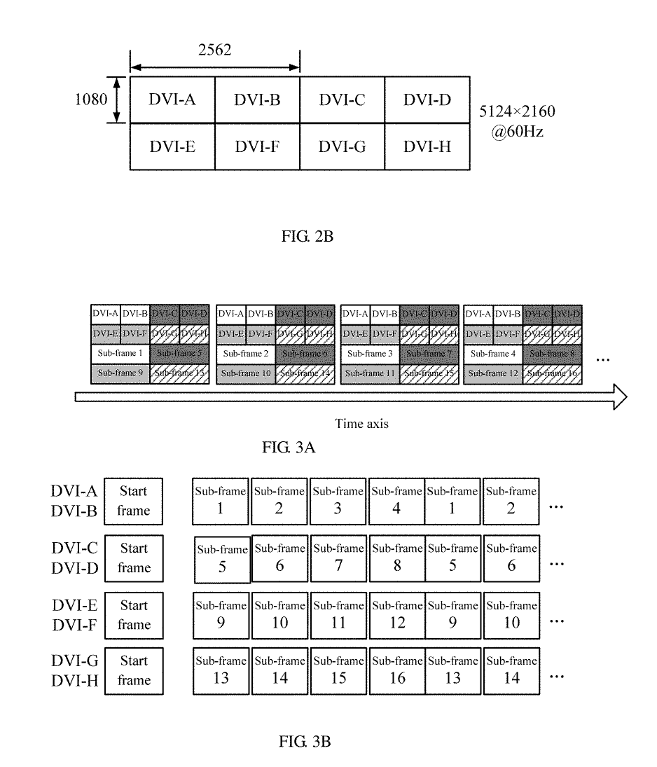

As an example, as illustrated in FIG. 2A, one frame of low resolution (e.g., 5K2K) image is segmented into four sub-frames. The number of sub-frames into which one frame of image is segmented can be determined based on a transmission rate of a port, which outputs the display data, of a playback device for playing a low resolution video signal and/or on a resolution of an image to be transmitted. Taking the presently prevalent DVI (Digital Visual Interface) data transmission port as an example, the highest resolution supported by a single-lane DVI usually is 1920*1200, and the highest resolution supported by a dual-lane DIV usually is 2560*1600. Accordingly, the number of the DVI ports adopted and the number of sub-frames into which an image is to be segmented can be determined based on the resolution of the image to be transmitted as well as the type of the DVI port adopted. For example, according to an embodiment of the present disclosure, in order to transmit one frame of image with a resolution of 5K2K, eight DVI ports can be adopted to transmit in parallel the four sub-frames into which one frame of image is segmented.

According to an embodiment of the present disclosure, taking a playback device that supports 5K2K@60 Hz as an example, the following mode can be adopted to segment one frame of video image into a plurality of sub-frames to output the frame of video image by region: Extend Display Identification Data (EDID) information on a playback device is modified by the video signal conversion apparatus according to the present disclosure, and written into the display output system of the playback device, so that the video image outputted from the playback device is segmented into a plurality of sub-frames to be thereby outputted.

According to an example, as illustrated in FIG. 2B, transmission ports DVI-A/B, DVI-C/D, DVI-E/F and DVI-G/H transmit in parallel four sub-frames segmented from one frame of the 5K2K image, respectively. In fact, as described above, the image to be transmitted can be divided into different numbers of sub-frames and transmitted in different ways depending on the transmission rate of the data port adopted for transmitting the video signal and the resolution of the image to be transmitted. For example, if the transmission rate of the data transmission port adopted is low, the number of the data transmission ports can be increased in order to transmit the video image with the same resolution, so as to ensure that no excessive signal display delay is introduced. Naturally, the DVI port described above is only an example of the video data transmission port of the present disclosure, the data transmission port for transmitting the video image outputted from the playback device to the video signal conversion apparatus is not limited to the DVI port, and other various data transmission ports can be adopted, without limitations herein.

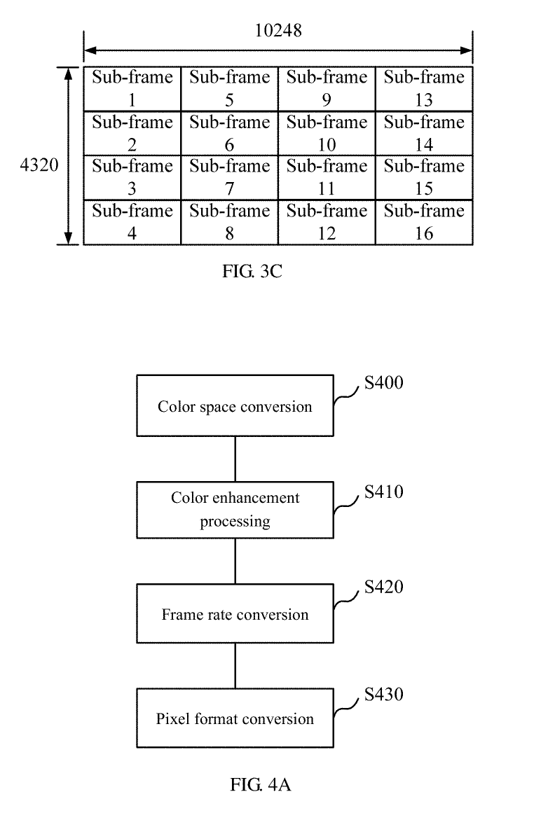

Taking a playback device for playing a video image with a resolution of 5K2K as an example, in order to be compatible with the 10K4K high-definition display screen, it needs to stitch four frames of 5K2K video images so as to be displayed on the 10K4K display screen; meanwhile, because directly stitching the low resolution images into a high resolution image reduces a refresh rate, and refresh rates of the playback device and the display screen are usually kept consistent with each other; thus, the frequency multiplication on the low resolution image can be performed before stitching. Accordingly, according to an embodiment of the present disclosure, a video signal conversion apparatus is connected between the playback device and the display screen so as to make a conversion on the low resolution image and thereby display a high resolution image on the high-definition display screen. Optionally, considering that the video signal outputted from the playback device is transmitted to the video signal conversion apparatus via a data transmission port (e.g., a DVI port), provided that eight DVI ports transmit one frame of 5K2K image coordinately at one time, eight DVI ports need to transmit four frames of 5K2K video image sequentially in a chronological order so as to stitch four frames into a high resolution image of 10K4K, wherein each frame of the 5K2K image is segmented into four sub-frames and four segmented sub-frames are transmitted in parallel. In other words, as illustrated in FIG. 3C, sixteen 2562*1080 sub-frames are required to obtain one frame of 10K4K high resolution image. Of course, the number of the sub-frames can be increased or decreased depending on the resolution of the sub-frames. FIGS. 3A-3B illustrate a schematic diagram of transmitting a 5K2K image with four DVI ports. As illustrated in FIG. 3A, four frames of 5K2K video image are sequentially transmitted on a time axis, wherein the first frame of video image is segmented into four sub-frames labeled as sub-frame 1, sub-frame 5, sub-frame 9 and sub-frame 13 respectively, the second frame of video image is segmented into four sub-frames labeled as sub-frame 2, sub-frame 6, sub-frame 10 and sub-frame 14 respectively, the third frame of video image is segmented into four sub-frames labeled as sub-frame 3, sub-frame 7, sub-frame 11 and sub-frame 15 respectively, and the fourth frame of video image is segmented into four sub-frames labeled as sub-frame 4, sub-frame 8, sub-frame 12 and sub-frame 16 respectively. In a chronological order, DVI-A/B transmits sub-frames 1, 2, 3 and 4 sequentially, DVI-C/D transmits sub-frames 5, 6, 7 and 8 sequentially, DVI-E/F transmits sub-frames 9, 10, 11 and 12 sequentially, and DVI-G/H transmits sub-frames 13, 14, 15 and 16 sequentially.

Accordingly, based on an embodiment of the present disclosure, in order to facilitate parsing the respective sub-frames in the video conversion apparatus, a start frame can be added when the playback device transmits the sub-frames. As such, it is possible to start counting when the video conversion apparatus receives the start frame, thereby distinguishing four sub-frames segmented from the one frame of video image transmitted. For example, as illustrated in FIG. 3B, for the transmission port DVI-A/B, the counting can be started upon the start sub-frame is received, thereby distinguishing sub-frame 1, sub-frame 2, sub-frame 3 and sub-frame 4; similarly, for the transmission port DVI-C/D, counting can be started upon the start sub-frame is received, thereby distinguishing sub-frame 5, sub-frame 6, sub-frame 7 and sub-frame 8; and so on and so forth, no more details are repeated here.

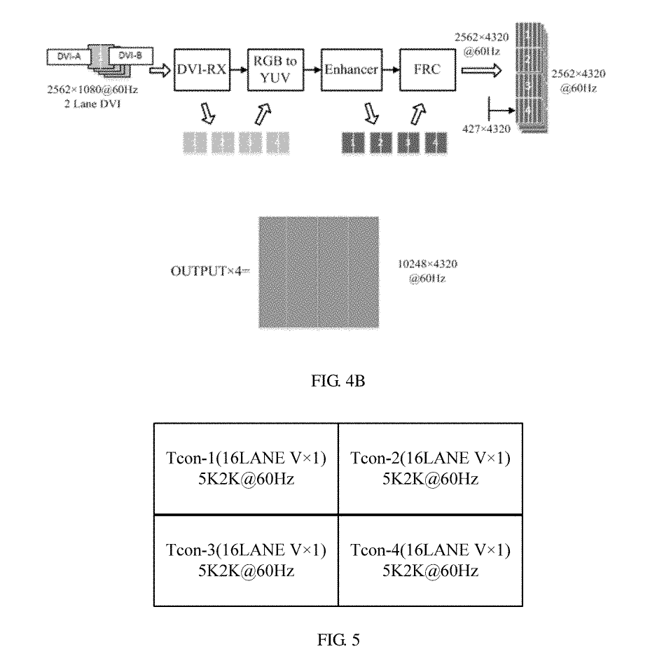

According to an embodiment of the present disclosure, after the video signal conversion apparatus receives a plurality of sub-frames segmented from one frame of low resolution image, image processing can be performed on each sub-frame so as to finally stitch them into one frame of high resolution image on a high-definition display screen. Specific processes of performing image processing on each sub-frame are illustrated below with the DVI-A/B port as an example. As illustrated in FIG. 4A, first, after receiving a sub-frame (e.g., sub-frame 1) via the transmission port DVI-A/B, sub-frame 1 is subjected to color space conversion as illustrated in step S400 to facilitate subsequent further processing. As an example, conversion from RGB color space to YUV color space can be performed on sub-frame 1, red (R), green (G) and blue (B) component values of each pixel dot in sub-frame 1 are converted into YUV values, wherein Y represents a luminance component of the pixel dot, U and V each represent a chromatic aberration component of the pixel dot, so that luminance information of the pixel dot is separated from chrominance information, which facilitates more efficient representation of a chromatic image. The color space conversion can also reduce data processing load and improve data processing efficiency.

Of course, color space conversion from RGB to YUV performed on the sub-frames as described above is merely an example of the present disclosure, various other forms of color space conversion, such as color space conversion from RGB to HSV, can be adopted by a person skilled in the art as desired, the present disclosure is not limited to performing color space conversion from RGB to YUV.

After color space conversion is performed, as illustrated in step S410, the sub-frames are subjected to color enhancement processing, thereby improving visual effect of the sub-frame image and highlighting features on the image. In fact, as well known to a person skilled in the art, various color enhancement algorithms can be adopted to perform color enhancement so as to improve visual effect of colors of the sub-frames, and no details are repeated here.

After color enhancement processing is completed, frame rate conversion is performed on the sub-frames as illustrated in step S420. The frame rate conversion can maintain the refresh rate of the entire image after the low resolution sub-frames are stitched into a high resolution image, and thus the frequency multiplication is performed on the sub-frames.

In addition, considering that a plurality of sub-frames are finally synthesized into one frame of high resolution image on a high-definition display screen for displaying and the data transmission rate of the data transmission port between the video signal conversion apparatus and the high-definition display screen is limited, pixel format conversion can be performed after frame rate conversion, as illustrated in step S430. In other words, in order to make full use of capability of the data transmission port between the video signal conversion apparatus and the high-definition display screen and improve signal transmission efficiency, a pixel format conversion can be performed on the image signal to be transmitted, so as to transmit an image signal, which is to be stitched into one frame of high resolution image, to a timing controller (T-CON) of the high-definition display screen in an appropriate data transmission manner, and finally a high resolution video image is displayed on the high-definition display screen.

It should be noted that, although steps of the image processing performed on each sub-frame in FIG. 4A are executed in a certain order, it does not indicate that the video signal conversion method of the present disclosure must be executed strictly in this order, nor does it indicate that all of the steps are necessary in any case. In practice, a person skilled in the art can change the order between the steps and even remove one or more of the steps depending on actual needs, without departing from the principles of the present disclosure. For example, the color space conversion step or the color enhancement processing step can be adjusted as needed.

FIG. 4B illustrates a signal flow of an example in which image processing is performed on a 2562*1080 sub-frame inputted via the transmission port DVI-A/B. As illustrated in FIG. 4B, after the sub-frame with 2562*1080@60 Hz received at the transmission port DVI-A/B is decoded, it is then subjected to color space conversion. Optionally, this sub-frame is converted from RGB space to YUV space; thereafter, the color space-converted sub-frame is subjected to color enhancement processing in a YUV space. In order to improve processing efficiency of the system and reduce hardware cost of the system, parallel processing are performed on two branches of 1281*1080@60 Hz video signals, wherein each branch can be regarded as four channels of 1281*1080@15 Hz video signals in a time dimension. After color enhancement processing is completed, frame rate conversion is performed on each sub-frame. According to an embodiment of the present disclosure, a frame rate conversion module cooperates with a Double Data Rate SDRAM (DDR) chip to complete a frame reproduction with fourfold frequency multiplication so as to achieve the frame rate conversion. Optionally, a 15 Hz video signal can be written to the DDR chip and the video signal can be read from the DDR chip at 60 Hz to thereby achieve frame rate conversion.

Specific steps of performing color space conversion, color enhancement processing and frame rate conversion are illustrated with reference to FIG. 4B by taking the case in which a dual-port DVI-A/B receives one 2562*1080 sub-frame as an example in the above. After frame rate conversion is completed, pixel format conversion can be performed on the plurality of sub-frames in order to transmit the respective processed sub-frames from the video signal conversion apparatus to the high-definition display screen so that the sub-frames are stitched into one frame of high resolution image. Optionally, four sub-frames that have been subjected to the frame rate conversion, for example, four sub-frames of sub-frame 1, sub-frame 2, sub-frame 3 and sub-frame 4 of 2562*1080@60 Hz, are stitched into a sub-image of 2562*4320@60 Hz in a column direction. In order to increase processing speed and reduce requirements on processing hardware, optionally, this sub-image can be divided so as to be processed on six channels in parallel, wherein each channel is 424*4320@60 Hz. The six channels of signal are processed in parallel in a pixel format conversion part. The four consecutive sub-frames received by each of the other dual-ports DVI-C/D, DVI-E/F and DVI-G/H are subjected to respective color space conversion, color enhancement processing and frame rate conversion, and then stitched into a sub-image of 2562*4320@60 Hz and divided into six channels of signal of 424*4320@60 Hz to be transmitted to the pixel format conversion part for processing. The pixel format conversion part converts said signal into a low voltage differential signal (LVDS) to output. In order to increase the data transmission rate and reduce the number of signal cables and connectors, thereby reducing cost and saving space, in consideration of increasing anti-jamming capability of signal transmission, optionally, the LVDS signal can be converted into a V-BY-ONE signal via a converter chip and be transmitted to the timing controller of the high-definition screen via a V-BY-ONE port of the video signal conversion apparatus. Specifically, the LVDS signal outputted from the pixel format conversion part can be converted into a V-BY-ONE signal via a signal converter chip, and a sub-image with a resolution of 5K2K@60 Hz is outputted to a timing controller (T-CON) of the high-definition display screen for example via a 16-lanes V-BY-ONE port, wherein the T-CON converts the received V-BY-ONE digital signal into RGB data driving signals and scanning drive signals so as to drive the high-definition display screen to display the image. In order to display an image with a resolution of for example 10K4K@60 Hz on the display, as illustrated in FIG. 5, four branches of 16-lanes V-BY-ONE ports can be used to transmit four frames of sub-image in parallel, and thereby the four frames of sub-image can be stitched into one complete frame of 10K4K@60 Hz high-definition image on the high-definition display screen.

Optionally, in consideration of adjacent edges, some columns or rows can be appropriately added for the sub-frames inputted via the DVI port, for example, it is not limited to 2562 rows or 1080 columns in 2562*1080, it can be slightly more than 2562 rows or 1080 columns.

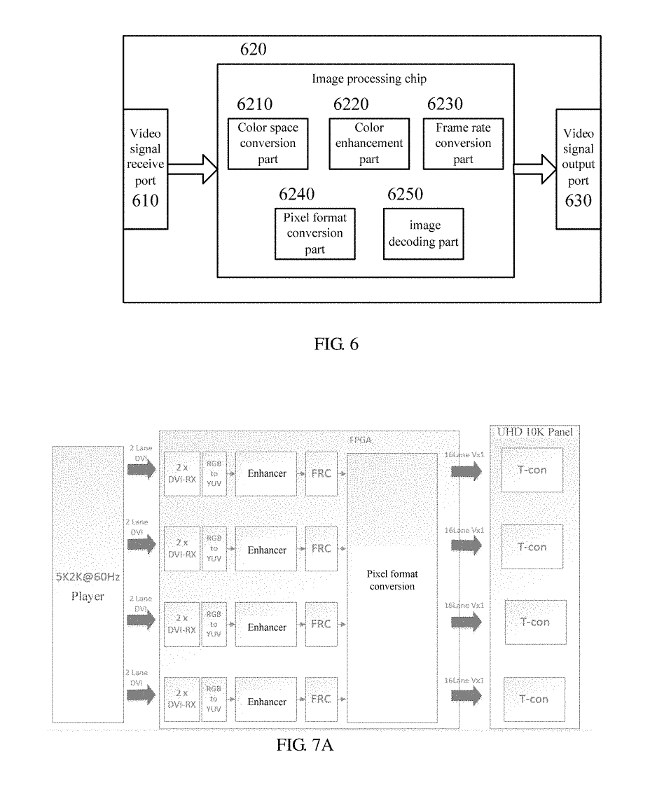

FIG. 6 illustrates a structural block diagram of a video signal conversion apparatus according to an embodiment of the present disclosure. As illustrated in FIG. 6, the video signal conversion apparatus comprises: at least one video signal receive port 610 for receiving a video signal from a video playback device; an image processing chip 620 for performing image processing on each frame of image in the received video signal; and at least one video signal output port 630 for outputting each frame of image that has been subjected to image processing to a display device.

Optionally, the image processing chip comprises: a color space conversion part 6210 for performing color space conversion on respective sub-frames received by the video signal receive port 610; a color enhancement part 6220 for performing color enhancement processing on respective sub-frames that have been subjected to color space conversion; a frame rate conversion part 6230 for performing frame rate conversion on respective sub-frames that have been subjected to color enhancement processing; and a pixel format conversion part 6240 for performing pixel format conversion on respective sub-frames that have been subjected to frame rate conversion and output respective sub-frames which are subjected to the pixel format conversion to the video signal output port 630.

Optionally, the image processing chip further comprises an image decoding part 6250 for decoding the received respective frames of image before the color space conversion part 6210 performs color space conversion on the respective frames of image.

Optionally, the video signal receive port adopts a DVI port, and the video signal output port adopts a V-BY-ONE port.

Optionally, the image processing chip is implemented by FPGA (Field-Programmable Gate Array). Alternatively, it is also possible to realize image processing on the respective frames by other hardware, including but not limited to DSP (Digital Signal Processor), ASIC (Application Specific Integrated Circuit), CPLD (Complex Programmable Logic Device), dedicated or general-purpose image processors, so as to achieve the same functionality, with no limitations made herein.

Optionally, in a case where a signal outputted from the pixel format conversion part is an LVDS signal, the video signal conversion apparatus (or the image processing chip 620) further comprises an LVDS conversion part for converting an LVDS signal into a V-BY-ONE signal to be outputted to the video signal output port 630.

The video signal conversion apparatus in the embodiment of the present disclosure will be described in detail below by taking the case in which a low resolution video signal of 5K2K@60 Hz outputted from a video playback device is converted into a high resolution video signal of 10K2K@60 Hz as an example. It should be noted that the number, type of elements for processing the video signal and the order of the relevant processing flows appearing in the following detailed description are not intended to limit the principles of the present disclosure but only examples introduced for the purpose of facilitating understanding of the principles of the present disclosure. In fact, according to the principles of the present disclosure, a person skilled in the art can increase or decrease the number of associated elements, replace certain types of elements with other types of elements, change the order of the processing flows or make them be executed in parallel, without departing from the principles of implementing the present disclosure. Optionally, one or more of the elements of the present disclosure can be integrated together or one separate element can be divided into several elements to achieve the same function. Such variations are also within the scope of the present disclosure.

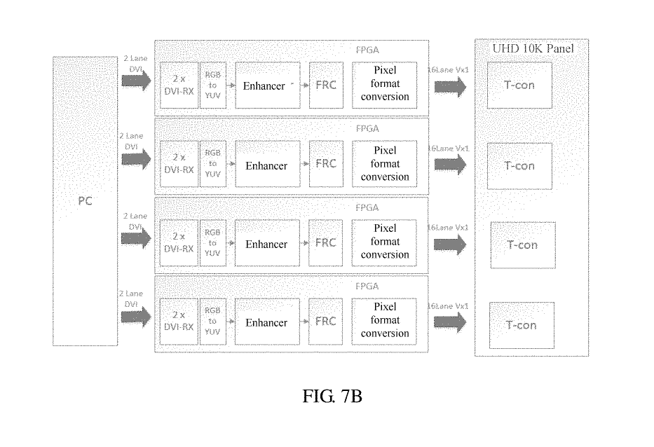

FIGS. 7A-7B illustrates a schematic configuration of a display system according to an embodiment of the present disclosure. As illustrated in FIG. 7A, the video signal conversion apparatus is connected between a player and a high-definition display panel, wherein the video signal conversion apparatus adopts a DVI port as a video signal receive port. As described above, in order to convert a low resolution video image (e.g., 5K2K@60 Hz) output from a video playback device (including but not limited to a personal computer, a television set, a DVR, a set-top box etc.) to a high-definition video image (e.g., 10K2K@60 Hz) that can be displayed on a high-definition display panel, the video signal conversion apparatus receives the low resolution video signal outputted from the video playback device. In view of a limited data transmission rate of the DVI port and in order to reduce hardware cost, in this embodiment, eight DVI ports are adopted to receive one frame of image outputted by the video playback device, wherein two DVI ports form a group to receive 2562*1080@60 Hz sub-frames segmented from a low resolution image.

Optionally, in a case where the playback device supports playing a video image at 5K2K@60 Hz, in order to divide one frame of video image into a plurality of sub-frames to perform output by region, EDID (Extend Display Identification Data) information on an FPGA board of the video signal conversion apparatus, which is connected to the playback device, can be modified and written into the display output system of the playback device, so that the video image outputted from the playback device is segmented into a plurality of sub-frames for being outputted. Optionally, as illustrated in FIG. 2A, the low resolution image of 5K2K@60 Hz outputted from the playback device is segmented into four sub-frames, and each sub-frame is transmitted via two DVI ports. In addition, the video signal receive port of the video signal conversion apparatus, which is used for receiving a video image outputted from the playback device, is not limited to the DVI port, and other various ports such as HMDI port can be adopted, with no limitations made herein. In this case, the number of sub-frames into which the video image outputted from the playback device is to be segmented can be determined based on the data transmission rate of the HMDI port.

As illustrated in FIG. 7A, four pairs of DVI ports are adopted to receive the 5K2K@60 Hz video signal outputted from the video playback device, where one pair of DVI ports corresponds to two DVI lanes and receives 2562*1080@60 Hz sub-frames. In order to improve system processing efficiency and reduce display delay due to signal processing, in the video signal conversion apparatus according to an embodiment of the present disclosure, four branches are adopted to perform image processing on the four sub-frames segmented from the 5K2K@60 Hz video signal in parallel. The following illustration is provided with the DVI-A/B port as an example. First, the received sub-frames are inputted to the image processing chip 620 and decoded by the image decoding part 6250 contained therein; naturally, can be unnecessary depending on the actual situation; then, the color space conversion part 6210 performs color space conversion on the decoded sub-frames. As an example, conversion from RGB color space to YUV color space can be performed on the sub-frames, red (R), green (G) and blue (B) component values of each pixel dot in a sub-frame are converted into YUV values, wherein Y represents a luminance component of the pixel dot, U and V each represents a chromatic aberration component of the pixel dot, so that luminance information of the pixel dot is separated from chrominance information, which facilitates more efficient representation of a chromatic image. The color space conversion can also reduce data processing load and improve data processing efficiency. Of course, color space conversion from RGB to YUV performed on the sub-frames as described above is merely an example of the present disclosure, various other forms of color space conversion, such as color space conversion from RGB to HSV, can be adopted by a person skilled in the art as desired, and thus the present disclosure is not limited to only performing color space conversion from RGB to YUV.

After color space conversion is performed by the color space conversion part 6210 on the sub-frames, the color enhancement part 6220 performs color enhancement processing on the sub-frames, thereby improving visual effect of the sub-frame image and highlighting detail features of the image. In fact, as well known to a person skilled in the art, various color enhancement algorithms can be used to perform color enhancement so as to improve visual effect of colors of the sub-frames, without details repeated here.

After color enhancement processing on the sub-frames is completed by the color enhancement part 6220, the frame rate conversion part 6230 performs frame rate conversion on the sub-frames. The frame rate conversion can keep the refresh rate of the image constant after the low resolution sub-frames are stitched into a high resolution image, so that the frequency multiplication operation is perform on the sub-frames.

Optionally, when one pair of DVI ports DVI-A/B receives the 2562*1080@60 Hz sub-frame, two branches of 1281*1080@60 Hz video signal can be concurrently subjected to image processing, wherein each branches can be divided into four channels of 1281*1080@15 Hz video signal in a time dimension for being processed. The frequency multiplication operation is perform on the 1281*1080@15 Hz video signal by the frame rate conversion part 6230; for example, the frame rate conversion part 6230 cooperates with a DDR chip to complete a frame reproduction with fourfold frequency multiplication so as to achieve the frame rate conversion. Optionally, a 15 Hz video signal can be written to the DDR chip and the video signal can be read from the DDR chip at 60 Hz to thereby achieve frame rate conversion.

Specific procedures of performing color space conversion, color enhancement processing and frame rate conversion on a sub-frame are illustrated in the above by taking the case in which two lanes of DVI signals form one sub-frame as an example. Optionally, since one pair of DVI ports, DVI-A and DVI-B, sequentially receives four sub-frames 1, 2, 3 and 4 of 2562×1080@60 Hz in a time dimension as illustrated in FIG. 3A, sixteen sub-frames received at four pairs of DVI ports need to be stitched so as to display a 10248*4320 video image on the high-definition display panel, wherein the stitching can be carried out in accordance with for example an arrangement illustrated in FIG. 3C; optionally, sub-frames 1, 2, 3 and 4 are sequentially from DVI-A/B, sub-frames 5, 6, 7 and 8 are sequentially from DVI-C/D, sub-frames 9, 10, 11 and 12 are sequentially from DVI-E/F, sub-frames 13, 14, 15 and 16 are sequentially from DVI-G/H. If such 2562*1080@60 Hz sub-frames are directly stitched into a 10248*4320 high resolution image, a refresh rate of the video image is decreased on the high-definition display panel. Therefore, before the stitching, the frame rate conversion part is used to perform reproduction with fourfold frequency multiplication on the respective sub-frames so as to match with the performance of the display panel with 10248*4320@60 Hz.

After the frame rate conversion part has completed the frame rate conversion on the sub-frames, pixel format conversion needs to be performed so that the respective sub-frames can be transmitted from the video signal conversion apparatus to the high-definition display panel to be finally stitched into a 10K4K@60 Hz high resolution image. The four sub-frames that have been subjected to frame rate conversion, for example, sub-frame 1, sub-frame 2, sub-frame 3 and sub-frame 4 of 2562*1080@60 Hz, are stitched into a 2562*4320@60 Hz sub-image in a column direction. In order to increase processing speed and reduce requirements on processing hardware, optionally, this sub-image can be divided so as to be processed in six channels in parallel as illustrated in FIG. 4B, wherein each channel represents 424*4320@60 Hz. These six channels of signal are transmitted to the pixel format conversion part 6240 for being processed in parallel, and converted into a low voltage differential signal (LVDS) signal to be output. Of course, it is described in the above that various processing are performed on sub-frames received by one pair of DVI ports, and similarly, sub-frames received by the other three pairs of DVI ports, after being subjected to the above process, are also outputted to the pixel format conversion part 6240; thus, sixteen sub-frames received by four pairs of DVI ports, after being subjected to the processing performed by the color space conversion part, the color enhancement part and the frame rate conversion part, are converted into an LVDS image signal by the pixel format conversion part.

In order to increase the data transmission rate and reduce the number of signal cables and connectors, thereby reducing cost, saving space, and increasing anti-jamming capability of signal transmission, optionally, the LVDS signal can be converted into a V-BY-ONE signal via a converter chip and be transmitted to the timing controller of the high-definition display via a V-BY-ONE port of the video signal conversion apparatus. Specifically, the LVDS signal outputted from the pixel format conversion part can be converted into a V-BY-ONE signal via a signal converter chip, and a sub-image with a resolution of 5K2K@60 Hz is outputted to a timing controller (T-CON) of the high-definition display screen for example via a 16-lanes V-BY-ONE port, and the received V-BY-ONE digital signal is converted into RGB data driving signals and scan driving signals by T-CON so as to drive the high-definition display screen to display the image. In order to display an image with a resolution of for example 10K4K@60 Hz on the display, as illustrated in FIG. 5, four branches of 16-lanes V-BY-ONE ports are required to transmit four frames of sub-image in parallel, and thereby the four frames of sub-image can be stitched into one frame of complete 10K4K@60 Hz high-definition image on the high-definition display screen.

Optionally, in consideration of processing of adjacent edges, several columns or rows can be appropriately added for the sub-frames inputted via the DVI port, for example, it is not limited to 2562 rows or 1080 columns in 2562*1080, and it can be slightly more than 2562 rows or 1080 columns.

Eventually, an image of 10K4K@60 Hz is displayed on the high-definition display panel.

As described above, the image processing chip in the video signal conversion apparatus of the present disclosure can be implemented by FPGA. In an implementation, as illustrated in FIG. 7A, one FPGA chip can be used to implement image processing on sub-frames received by all of the video signal receive ports, where a separate image processing channel is provided for each pair of DVI ports, so as to perform color space conversion, color enhancement and frame rate conversion on the respective sub-frames. Finally, all sub-frames are subjected to pixel format conversion, and an LVDS signal outputted from the pixel format conversion part is converted into a V-BY-ONE signal and outputted to the display panel via a video signal output port.

Optionally, as illustrated in FIG. 7B, a single FPGA chip can be provided for each pair of DVI ports to perform image processing on the respective sub-frames received by this pair of DVI ports, i.e., each FPGA chip individually performs color space conversion, color enhancement, frame rate conversion and pixel format conversion on sub-frames received via one pair of DVI ports, and converts an LVDS signal outputted from the pixel format conversion part into a V-BY-ONE signal and outputs the same to the display panel through a video signal output port. In other words, sub-frames received by each pair of DVI ports are subjected to video signal conversion by using the FPGA corresponding to the pair of DVI ports.

In addition, although it is illustrated in FIGS. 7A and 7B that the high-definition display panel comprises four timing controllers (T-CON), each of which is used for a video signal transmitted by one branch of 16-lanes V-BY-ONE port, i.e., 5K2K@60 Hz signal, this is just an example. In fact, it is fully possible to use one timing controller to process video signals transmitted from four branches of 16-lanes V-BY-ONE ports, so as to drive the high-definition display to display the 10K4K@60 Hz video image. Therefore, the present disclosure makes no limitations to the number of timing controllers in the high-definition display panel.

In the video signal conversion method, the video signal conversion apparatus and the display system according to the present disclosure, a video image with a relatively low resolution can be stitched into a video image with a high resolution on an ultra-high-definition display screen for displaying, so that a playing device for playing a video image with a low resolution can be compatible with an ultra-high-definition display screen for displaying a video image with a high resolution, thus displaying the high resolution image, enhancing compatibility, reducing cost of the display system, and facilitating popularity of the high-definition display system.

The above described merely are specific implementations of the present disclosure, and the protection scope of the present disclosure is not limited thereto; modification and replacements easily conceivable for a person skilled in the art within the technical range revealed by the present disclosure all fall into the protection scope of the present disclosure. Therefore, the protection scope of the present disclosure should be determined based on the protection scope of the claims.

The present application claims priority of the Chinese Patent Application No. 201510617475.X filed on Sep. 24, 2015, the entire disclosure of which is hereby incorporated in full text by reference as part of the present application.

1. A video signal conversion method, comprising:
receiving in parallel a plurality of sub-frames segmented from a low resolution image of a video signal;
performing image processing on each received sub-frame; and
synthesizing a plurality of sub-frames that has been subjected to image processing into one frame of high resolution image to be displayed on a display device.

2. The video signal conversion method according to claim 1, wherein the image processing is performed in parallel on the plurality of sub-frames segmented from one frame of low resolution image in a plurality of processing channels.

3. The video signal conversion method according to claim 1, wherein the image processing comprises at least one of color space conversion, color enhancement processing, frame rate conversion and pixel format conversion.

4. The video signal conversion method according to claim 1, wherein the number of the plurality of sub-frames into which the low resolution image is segmented is determined based on at least one of a resolution of the low resolution image and a transmission rate of a data port receiving the low resolution image.

5. The video signal conversion method according to claim 3, wherein the color space conversion comprises converting respective sub-frames from a RGB color space to a YUV color space.

6. The video signal conversion method according to claim 3, wherein a multiple of the frame rate conversion is determined based on a ratio of the resolution of the high resolution image to that of the low resolution image.

7. The video signal conversion method according to claim 3, wherein the plurality of sub-frames that has been subjected to the frame rate conversion is converted into an LVDS signal via the pixel format conversion, and the LVDS signal is converted into a V-BY-ONE signal via a signal format conversion to be outputted to a display device.

8. A video signal conversion apparatus, comprising:
a video signal receive port configured to receive in parallel a plurality of sub-frames segmented from a low resolution image;
an image processor configured to perform image processing on each received sub-frame; and
a video signal output port configured to output the plurality of sub-frames that has been subjected to the image processing to a display device so as to be synthesized into one frame of high resolution image to be displayed.

9. The video signal conversion apparatus according to claim 8, wherein the image processor is configured to perform the image processing in parallel on the plurality of sub-frames segmented from one frame of low resolution image in a plurality of processing channels.

10. The video signal conversion apparatus according to claim 8, wherein the image processor comprises:
a color space conversion part configured to perform a color space conversion on a sub-frame;
a color enhancement part configured to perform color enhancement processing on the sub-frame that has been subjected to the color space conversion;
a frame rate conversion part configured to perform a frame rate conversion on the sub-frame that has been subjected to the color enhancement processing; and
a pixel format conversion part configured to perform a pixel format conversion on the sub-frame that has been subjected to the frame rate conversion and output the converted sub-frame to the video signal output port.

11. The video signal conversion apparatus according to claim 8, wherein the number of the plurality of sub-frames into which the low resolution image is segmented is determined based on at least one of a resolution of the low resolution image and a transmission rate of the video signal receive port for receiving the low resolution image.

12. The video signal conversion apparatus according to claim 10, wherein the color space conversion part is configured to convert the received sub-frame from a RGB color space to a YUV color space.

13. The video signal conversion apparatus according to claim 10, wherein a multiple of the frame rate conversion is determined based on a ratio of the resolution of the high resolution image to that of the low resolution image.

14. The video signal conversion apparatus according to claim 10, further comprising a signal format conversion part;
wherein the pixel format conversion part is configured to convert the plurality of sub-frames that has been subjected to the frame rate conversion into an LVDS signal, and the signal format conversion part is configured to convert the LVDS signal into a V-BY-ONE signal to be outputted to a display device.

15. A display system, comprising a playback device, a high-definition display, and the video signal conversion apparatus according to in claim 8.

16. The display system according to claim 15, wherein the image processor is configured to perform the image processing in parallel on the plurality of sub-frames segmented from one frame of low resolution image in a plurality of processing channels.

17. The display system according to claim 15, wherein the image processor comprises:
a color space conversion part configured to perform a color space conversion on a sub-frame;
a color enhancement part configured to perform color enhancement processing on the sub-frame that has been subjected to the color space conversion;
a frame rate conversion part configured to perform a frame rate conversion on the sub-frame that has been subjected to the color enhancement processing; and
a pixel format conversion part configured to perform a pixel format conversion on the sub-frame that has been subjected to the frame rate conversion and output the converted sub-frame to the video signal output port.

18. The display system according to claim 15, wherein the number of the plurality of sub-frames into which the low resolution image is segmented is determined based on at least one of a resolution of the low resolution image and a transmission rate of the video signal receive port for receiving the low resolution image.

19. The display system according to claim 17, wherein the color space conversion part is configured to convert the received sub-frame from a RGB color space to a YUV color space.

20. The display system according to claim 17, wherein a multiple of the frame rate conversion is determined based on a ratio of the resolution of the high resolution image to that of the low resolution image.
